(19) United States
(12) Patent Application Publication
(10) Pub. No.: US 2025/0086343 A1
(43) Pub. Date: Mar. 13, 2025

(54) SETTING METHOD FOR AIR-CONDITIONING MACHINE ROOM, DEVICE, ELECTRONIC EQUIPMENT, AND READABLE STORAGE MEDIUM

(71) Applicants: SHANGHAI M-BMS INTELLIGENT CONSTRUCTION CO., LTD., Shanghai (CN); GD MIDEA HEATING & VENTILATING EQUIPMENT CO., LTD., Foshan (CN)

(72) Inventors: Yide QIU, Foshan (CN); Rui LIANG, Foshan (CN); Liang LUO, Foshan (CN); Yuanyang LI, Foshan (CN); Qin LIANG, Foshan (CN); Zhongsheng SHI, Foshan (CN); Kuang CHENG, Foshan (CN)

(21) Appl. No.: 18/564,024

(22) PCT Filed: Sep. 5, 2022
(86) PCT No.: PCT/CN2022/117092

§ 371 Date: Nov. 24, 2023

(30) Foreign Application Priority Data
Sep. 17, 2021 (CN) 202111092475.4

(51) Int. Cl. G06F 30/18; G06F 119/02

(52) U.S. Cl. CPC G06F 30/18; G06F 2119/02

(57) ABSTRACT

A setting method includes determining a specification of a chiller unit of an air-conditioning machine room based on a cooling load of a building. The specification of the chiller unit includes an inlet and outlet specification and a pipe diameter. The method further includes determining a specification of a water pump of the air-conditioning machine room based on a preset system water flow, and determining a valve member of the air-conditioning machine room. A specification of the valve member matches the pipe diameter. The method also includes plotting the chiller unit, the water pump, and the valve member on a design layout, and connecting the chiller unit, the water pump, and the valve member The chiller unit, the water pump, and the valve member are proportionally scaled according to the specification of the chiller unit, the specification of the water pump, and the specification of the valve member.

### CROSS-REFERENCE TO RELATED APPLICATIONS

This application claims priority to Chinese Patent Application No. 202111092475.4 filed with the China Patent Office on Sep. 17, 2021, entitled “Setting Method for Air-Conditioning Machine Room, Device, Electronic Equipment, and Readable Storage Medium,” the entire content of which is incorporated herein by reference.

### TECHNICAL FIELD

The present disclosure relates to the field of air-conditioning technology, and in particular, to a setting method for an air-conditioning machine room, a device, electronic equipment, and a readable storage medium.

### BACKGROUND

In related technologies, the design of a machine room system of central air-conditioning has complicated and chaotic layout of pipelines, which may lead to problems such as crowded locations and pipeline crossings, which then increases the space requirement of the machine room and the pipeline resistance of the system, increases the energy consumption of the machine room system, and cannot intuitively reflecting the spatial location relationship of the machine room. The designed machine room has poor adaptability.

### SUMMARY

The present disclosure provides a setting method for an air-conditioning machine room, a device, electronic equipment and a readable storage medium, to at least ensure that the spatial positional relationship of the machine room can be intuitively reflected during the layout of the machine room. The designed machine room has strong adaptability and is convenient to use.

In accordance with some embodiments of the present disclosure, a setting method for an air-conditioning machine room is provided. The air-conditioning machine room may include a chiller unit, a water pump and a valve member. The method may include: determining a specification of the chiller unit based on a cooling load of a building, where, the specification of the chiller unit includes an inlet and outlet specification and a pipe diameter; determining a specification of the water pump based on a preset system water flow; determining a valve member, where a specification of the valve member matches the pipe diameter; and plotting the chiller unit, the water pump and valve member on a design layout, and connecting the chiller unit, the water pump and the valve member, where, the chiller unit, the water pump and the valve member are scaled according to the specifications.

In accordance with some embodiments of the present disclosure, a setting device for an air-conditioning machine room is provided. The air-conditioning machine room may include a chiller unit, a water pump, and a valve member. The setting device may include: a chiller unit specification determination device which is configured to determine a specification of the chiller unit based on a preset flow rate of an air-conditioning water pipe, where the specification of the chiller unit includes an inlet and outlet specification and a pipe diameters; a water pump specification determination device which is configured to determine a specification of the water pump based on a preset system water flow; a valve member specification determination device which is configured to determine the valve member whose specification matches the pipe diameter; and an equipment plotting connection device which is configured to plot the chiller unit, the water pump and the valve member on a design layout, and connect the chiller unit, the water pump and the valve member, where, the chiller unit, the water pump and the valve member are scaled according to the specifications.

In accordance with some embodiments of the present disclosure, a piece of electronic equipment is provided. The electronic equipment may include a processor and a memory. The memory stores a computer-executable instruction that is executable by the processor. The processor, when executing the computer-executable instruction, is configured to implement the above-mentioned setting method for the air-conditioning machine room.

In accordance with some embodiments of the present disclosure, a computer-readable storage medium is provided, in which a computer-executable instruction is stored. The computer-executable instruction, when invoked and executed by a processor, causes the processor to implement the above-mentioned setting method for the air-conditioning machine room.

Other features and advantages of the present disclosure will be set forth in the subsequent description, or some of the features and advantages may be inferred or unambiguously determined from the description, or may be learned by practicing the above-mentioned techniques of the present disclosure.

In order to make the above-mentioned objectives, features and advantages of the present disclosure more obvious and comprehensible, preferred embodiments are given below and described in detail with reference to the accompanying drawings.

### DESCRIPTION OF THE DRAWINGS

In order to explain the technical solutions in the specific embodiments of the present disclosure or related technologies more clearly, the drawings that need to be used in the description of the specific embodiments or related technologies will be briefly introduced below. Obviously, the drawings in the following description are some embodiments of the present disclosure, those of ordinary skill in the art can also obtain other drawings based on these drawings without exerting creative efforts.

FIG. 1 is a flow chart of a setting method for an air-conditioning machine room according to some embodiments of the present disclosure;

FIG. 2 is a flow chart of another setting method for an air-conditioning machine room provided by some embodiments of the present disclosure;

FIG. 3 is a schematic diagram of a check valve provided by some embodiments of the present disclosure;

FIG. 4 is a schematic diagram of a rubber soft connection provided by some embodiments of the present disclosure;

FIG. 5 is a schematic diagram of a right-angle filter provided by some embodiments of the present disclosure;

FIG. 6A and FIG. 6B are a cross-sectional view and a top view, respectively, showing an arrangement of a water pump and a chiller unit where a freezing pipe and a cooling pipe enter and exit from different sides according to some embodiments of the present disclosure;

FIG. 7A and FIG. 7B are a cross-sectional view and a top view, respectively, showing an arrangement of the water pump and the chiller unit where the freezing pipe and the cooling pipe enter and exit on the same side according to some embodiments of the present disclosure;

FIG. 8 is a schematic structural diagram of a setting device for an air-conditioning machine room according to some embodiments of the present disclosure; and

FIG. 9 is a schematic structural diagram of a piece of electronic equipment provided by some embodiments of the present disclosure.

### LISTING OF REFERENCE NUMERALS

31—valve body; 32—valve flap; 33—valve cover; 81—chiller unit specification determination device; 82—water pump specification determination device; 83—valve member specification determination device; 84—equipment plotting connection device; 100—memory; 101—processor; 102—bus; and 103—communication interface.

### DETAILED DESCRIPTION OF THE EMBODIMENTS

In order to make the purpose, technical solutions and advantages of the embodiments of the present disclosure much clearer, the technical solutions of the present disclosure will be clearly and completely described below in conjunction with the drawings. Obviously, the described embodiments are some embodiments of the present disclosure, not all embodiments of the present disclosure. Based on the embodiments in this disclosure, all other embodiments obtained by those of ordinary skill in the art without exerting creative efforts shall fall within the protection scope of this disclosure.

At present, in the related technologies, the design of the machine room system of central air-conditioning has complicated and chaotic layout of pipelines, which may lead to the problems of crowded locations and pipeline crossings, which then increases the space requirements of the machine room and the pipeline resistance of the system, increases the energy consumption of the machine room system, and cannot intuitively reflect the spatial location relationship of the machine room. The designed machine room has poor adaptability and is difficult to use.

On basis of this, embodiments of the present disclosure provide a setting method for an air-conditioning machine room, a device, electronic equipment, and a readable storage medium. Particularly, the present disclosure relates to a standard layout type of an efficient machine room, which enables a convenient and quick layout of the machine room, and has a compact space structure, while reducing the pipeline resistance of the system and improving the overall energy efficiency of the system.

A setting method for an air-conditioning machine room provided according to embodiments of the present disclosure will be described in detail below with reference to the accompanying drawings.

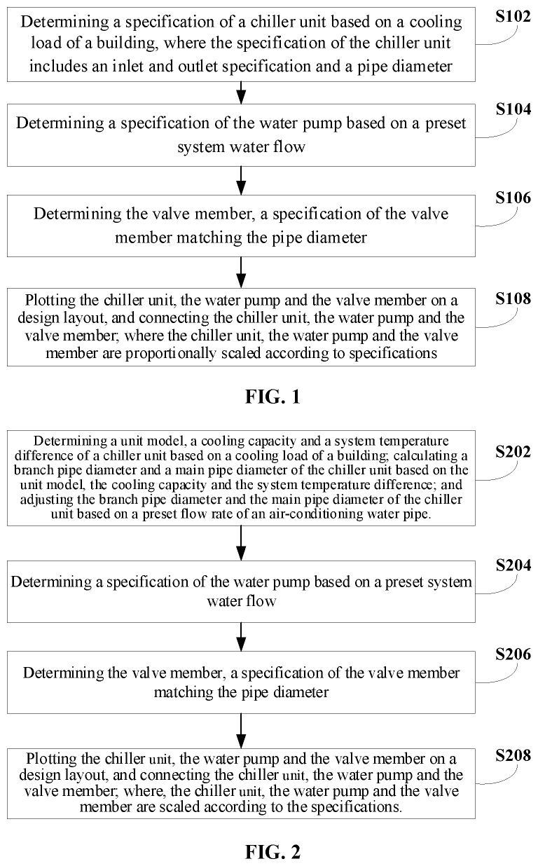

An embodiment of the present disclosure provides a setting method for an air-conditioning machine room. The air-conditioning machine room may include a chiller unit, a water pump and a valve member. Referring to the flow chart of the setting method for the air-conditioning machine room shown in FIG. 1, the setting method for the air-conditioning machine room may include the following steps, S102, S104, S106 and S108.

In step S102, a specification of the chiller unit is determined based on a cooling load of a building, where the specification of the chiller unit includes an inlet and outlet specification and a pipe diameter.

In this embodiment, the cooling load of the building may be understood as a cooling capacity required by the building containing the air-conditioning machine room. The machine room in this embodiment may be a machine room equipped with a central air-conditioning system, where the air-conditioning machine room may include the chiller unit, the water pump, and the valve member; the water pump may include a chilled water pump and a cooling water pump; and the valve member may include a rubber soft connection, a variable diameter, a swing check valve, a right angle filter, a butterfly valve, a pressure gauge, a drain valve, a heat meter, etc.

In addition, the number and model of the equipment and valve member in the air-conditioning machine room are not limited in this embodiment. For example, multiple chiller units may be arranged in the air-conditioning machine room, and the models of the chiller units may be different.

During a determination of the specification of the chiller unit in the machine room, firstly, a unit model, a cooling capacity, a system temperature difference and other parameters of the chiller unit are obtained. These parameters may be obtained from the nameplate and instructions of the chiller unit. Based on these parameters, the inlet and outlet specification and the pipe diameter of the chiller unit may be calculated, as the specification of the chiller unit. And then, an appropriate chiller unit pipelines may be selected based on the above calculation results.

In step S104, a specification of the water pump is obtained based on a preset system water flow.

The water pump in the air-conditioning machine room may include a chilled water pump and a cooling water pump. Specifications of these two types of water pumps are determined in a similar way and will be explained here. First of all, the air-conditioning machine room in this embodiment may include the above two types of water pumps, or may include only one type of water pump, or even neither type of water pumps. If it is determined in this step that the above two types of water pumps are not included, then it may be determined that the specification of the water pump is empty.

During a determination of the specification of the water pump in the machine room, firstly, a water flow of a machine room system is obtained, and then a water pump of appropriate model and specification is obtained based on the water flow. If the water flow is small, then a water pump having a small pump body and a small footprint may be selected, such as a vertical single stage pump; if the water flow is large, then a water pump having a large pump body and a large footprint may be selected such as a horizontal double suction pump.

In step S106, a valve member is determined, where a specification of the valve member matches the pipe diameter.

After the specifications of the refrigeration unit and water pump in the machine room are determined, the valve member for the refrigeration unit may be determined. The specification of the valve member for the refrigeration unit need to match the pipe diameter of the refrigeration unit. Particularly, the specification of the valve member for the refrigeration unit and the pipe diameter of the refrigeration unit may be matched by looking up a size specification table of various valve members. For example, taking the check valve as an example, a nominal diameter of the check valve (that is, the specification of the check valve) that matches the pipe diameter of each connection pipe of the refrigeration unit may be looked up in a standard specification size table of the check valve. Based on a look-up result, an appropriate check valve can be selected.

In step S108, the chiller unit, the water pump and the valve member are plotted on a design layout, and the chiller unit, the water pump and valve member are connected; where the chiller unit, the water pump and the valve member are scaled according to the specifications.

After the specifications of the chiller unit, the water pump and the valve member are determined, the chiller unit, the water pump and the valve member may be plotted on the design layout. The design layout may be plotted using different software, such as an AutoCAD (Autodesk Computer Aided Design) software. In this step, the chiller unit, the water pump and the valve member are scaled according to the specifications when plotting, which may ensure that the spatial position relationship of the machine room can be intuitively reflected when the air-conditioning machine room is laid out.

After the plotting of the chiller unit, water pump and valve member is completed, the chiller unit, water pump and valve member need to be connected. In this step, the chiller unit and the water pump may be connected in a direct connection manner to improve the efficiency of the water pump.

In the setting method for the air-conditioning machine room provided by the embodiment of the present disclosure, the chiller unit, the water pump and the valve member are scaled for plotting, and are connected after the specifications of the chiller unit, water pump and valve member are determined. Thus, it is ensured the spatial location relationship of the machine room can be intuitively reflected during the layout of the air-conditioning machine room. The designed air-conditioning machine room has strong adaptability and is convenient to use.

Another setting method for an air-conditioning machine room according to an embodiment of the present disclosure will be described in detail below with reference to the accompanying drawings.

The embodiment of the present disclosure provides another setting method for an air-conditioning machine room. This method is implemented on the basis of the above embodiment. The air-conditioning machine room in this embodiment may include a chiller unit, a cooling water pump, a chilled water pump, a rubber soft connection, a variable diameter, a swing check valve, a right-angle filter, a butterfly valve, a pressure gauge, a drain valve, a heat meter and other equipment and a valve member.

Based on the above description, as shown in FIG. 2 is a flow chart of another setting method for an air-conditioning machine room. The setting method for the air-conditioning machine room in this embodiment may include the following steps S202, S204, S206 and S208.

In step S202, a unit model, a cooling capacity and a system temperature difference of the chiller unit are determined based on a cooling load of a building; a branch pipe diameter and a main pipe diameter of the chiller unit are calculated based on the unit model, the cooling capacity and the system temperature difference; and the branch pipe diameter and the main pipe diameter of the chiller unit are adjusted based on a preset flow rate of an air-conditioning water pipe.

Where, a correspondence relationship between the cooling load of the building and the cooling capacity of the chiller unit may be stored in advance. After the cooling load of the building is determined, the cooling capacity of the chiller unit can be determined based on the above correspondence relationship. In addition, a correspondence relationship between the cooling load of the building and the unit model of the chiller unit may also be stored in advance. After the cooling load of the building is determined, the unit model of the chiller unit can be determined based on the above correspondence relationship, and then the cooling capacity of the unit model may be determined by using other methods.

For example, the unit model of the chiller unit may be obtained from the nameplate of the chiller unit, and the cooling capacity of the chiller unit may also be obtained from the nameplate of the chiller unit. If the chiller unit's nameplate does not indicate the cooling capacity of the chiller unit, then a water tank volume and a performance coefficient of the chiller unit may be obtained from the nameplate first. The performance coefficient is generally a COP (energy efficiency ratio, Coefficient of Performance). Then, a specified time corresponding to a rise of the chiller unit to a specified temperature is measured, and the cooling capacity of the chiller unit is calculated through the following formula, the water tank volume×the specified temperature÷the specified time÷the performance coefficient.

The system temperature difference of the chiller unit may be understood as a difference in cooling water temperature, that is, the difference between a cooling water inlet temperature and a cooling water outlet temperature. Also, the system temperature difference may generally be read from the nameplate or instructions of the chiller unit.

The branch pipe diameter and the main pipe diameter of the chiller unit may be calculated based on the unit model, the cooling capacity and the system temperature difference. Among them, the branch pipe diameter and the main pipe diameter obtained through calculation need to meet an economic flow rate requirement of the air-conditioning water pipe. If the branch pipe diameter and the main pipe diameter obtained through calculation fail to meet the economic flow rate requirement of the air-conditioning water pipe, then the branch pipe diameter and the main pipe diameter of the chiller unit need to be adjusted according to the flow rate requirement of the air-conditioning water pipe.

In step S204, a specification of the water pump is determined based on a preset system water flow.

Water pumps of different specifications have different characteristics. Among them, a factor of the system water flow should be considered when determining the specification of the water pump. For example, in case that the preset system water flow is smaller than a preset flow threshold, then the water pump is determined to be a vertical single-stage pump; and in case that the system water flow is greater than or equal to the preset flow threshold, then the water pump is determined to be a horizontal double-suction pump.

Taking the preset flow threshold of 300 m³/h as an example, if the system water flow is <300 m³/h, then a vertical single-stage pipeline pump may be selected, which has the characteristics of a small pump body and a small footprint; if the system water flow is >300 m³/h, then a horizontal double-suction pump may be selected, this type of water pump may be suitable for a machine room systems having a large water flow and has a high efficiency.

In step S206, the valve member is determined, where a specification of the valve member matches the pipe diameter.

The valve member whose specification matching the pipe diameter may be determined according to the pipe diameter of the chiller unit determined in the above step. Among them, correspondence relationships between different types of valve member and the pipe diameter of the chiller unit may be different. The following steps may be performed, including: determining a type of valve member and a correspondence relationship between this type of valve member and the pipe diameter of the chiller unit; and determining the valve member that matches the pipe diameter based on the correspondence relationship.

Where, the valve member may include a check valve, a rubber soft connection and a right-angle filter. To reduce a pipeline resistance of the machine room system, a low-resistance pipeline valve may be used; and correspondingly a swing check valve may be selected as the check valve, which can reduce the energy consumption of the machine room system.

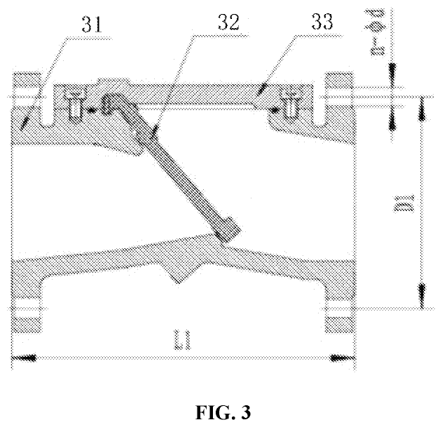

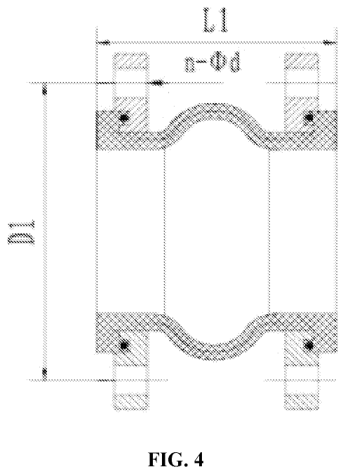

Taking the check valve as an example, with reference to the schematic diagram of a check valve shown in FIG. 3 and Table 1. Table 1 shows a standard size specification table of the check valve. The check valve may include a valve body 31, a valve flap 32 and a valve cover 33. As shown in FIG. 3 and Table 1, the specification of the check valve includes a nominal diameter, L1, D1 and N-Φd. During a selection of check valve, the check valve having a suitable nominal diameter may be selected based on the pipe diameter of the chiller unit calculated in the previous step, and it is determined whether the parameters such as L1, D1 and N-Φd of the check valve of this nominal diameter are appropriate.

TABLE 1
Standard Size Specification Sable of Check Valve

| Nominal | | D1 | | N-Φd | |
|---|---|---|---|---|---|
| Diameter | L1 | 1.0 MPa | 1.6 MPa | 1.0 MPa | 1.6 MPa |
| 50 | 203 | 125 | 125 | 4-18 | 4-18 |
| 65 | 216 | 145 | 145 | 4-18 | 4-18 |
| 80 | 241 | 160 | 160 | 8-18 | 8-18 |
| 100 | 292 | 180 | 180 | 8-18 | 8-18 |
| 125 | 330 | 210 | 210 | 8-18 | 8-18 |
| 150 | 356 | 240 | 240 | 8-22 | 8-22 |
| 200 | 495 | 295 | 295 | 8-22 | 12-22 |
| 250 | 622 | 350 | 355 | 12-22 | 12-22 |
| 300 | 698 | 400 | 410 | 12-22 | 12-26 |
| 350 | 787 | 460 | 470 | 16-22 | 16-26 |
| 400 | 914 | 515 | 525 | 16-26 | 16-30 |
| 450 | 978 | 565 | 585 | 20-26 | 20-30 |
| 500 | 978 | 620 | 650 | 20-26 | 20-33 |
| 600 | 1295 | 725 | 770 | 20-30 | 20-36 |

Then, taking the rubber soft connection as an example, with reference to the schematic diagram of a rubber soft connection shown in FIG. 4 and Table 2. Table 2 is a standard size specification table of the rubber soft connection (also referred to as a rubber hose). As shown in FIG. 4 and Table 2, the specification of rubber soft connection includes a nominal diameter, L1, an axial displacement (including an elongation and a compression), a lateral displacement and an offset angle. During a selection of rubber soft connection, the rubber soft connection having a suitable nominal diameter may be selected according to the pipe diameter of the chiller unit calculated in the previous step, and it is determined whether the parameters such as L1, the axial displacement (including the elongation and the compression), the lateral displacement and the offset angle of the rubber soft connection of this nominal diameter are appropriate.

TABLE 2
Standard Size Specification Table of Rubber Soft Connection

| Nominal | | Axial Displacement | | Lateral | Offset |
|---|---|---|---|---|---|
| Diameter | L1 | Elongation | Compression | Displacement | Angle |
| 80 | 135 | 8 | 15 | 12 | 15° |
| 100 | 150 | 10 | 19 | 13 | 15° |
| 125 | 165 | 12 | 19 | 13 | 15° |
| 150 | 180 | 12 | 20 | 14 | 15° |
| 200 | 210 | 16 | 25 | 22 | 15° |
| 250 | 230 | 16 | 25 | 22 | 15° |
| 300 | 245 | 16 | 25 | 22 | 15° |
| 350 | 255 | 16 | 25 | 22 | 15° |
| 400 | 255 | 16 | 25 | 22 | 15° |
| 450 | 255 | 16 | 25 | 22 | 15° |
| 500 | 255 | 16 | 25 | 22 | 15° |
| 600 | 260 | 16 | 25 | 22 | 15° |
| 700 | 260 | 16 | 25 | 22 | 15° |
| 800 | 260 | 16 | 25 | 22 | 15° |
| 900 | 260 | 16 | 25 | 22 | 15° |

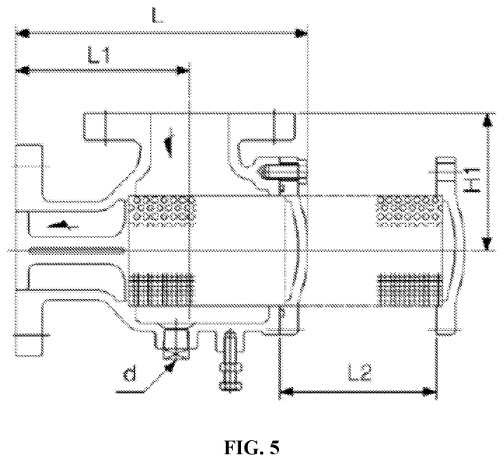

Then, taking the right-angle filter as an example, with reference to the schematic diagram of a right-angle filter shown in FIG. 5 and Table 3. Table 3 is a standard size specification table of the right-angle filter. As shown in FIG. 5 and Table 3, the specification of the right-angle filter includes an inlet, an outlet, L, L1, L2, H1, d and other parameters. During a selection of right-angle filter, the right-angle filter having a suitable specification may be obtained based on the pipe diameter of the chiller unit calculated in the previous steps.

TABLE 3

| | Inlet | | | | | | | | | | | |
|---|---|---|---|---|---|---|---|---|---|---|---|---|
| | DN | DN | DN | DN | DN | DN | DN | DN | DN | DN | DN | DN |
| | 50 | 65 | 80 | 100 | 150 | 200 | 250 | 300 | 350 | 400 | 500 | 600 |
| | Outlet | | | | | | | | | | | |
| | DN | DN | DN | DN | DN | DN | DN | DN | DN | DN | DN | DN |
| | 50 | 65 | 80 | 100 | 150 | 200 | 250 | 300 | 350 | 400 | 500 | 600 |
| L | 211 | 239 | 268 | 311 | 399 | 496 | 585 | 686 | 751 | 819 | 950 | 1060 |
| L1 | 130 | 146 | 163 | 195 | 256 | 301 | 354 | 425 | 464 | 491 | 550 | 550 |
| L2 | 103 | 126 | 147 | 170 | 228 | 285 | 360 | 430 | 482 | 525 | 695 | 800 |
| H1 | 102 | 111 | 128 | 152 | 203 | 251 | 291 | 341 | 379 | 402 | 460 | 550 |

| | | | |
|---|---|---|---|
| d | NPT ½″-14 | NPT ¾″-14 | NPT 1″-11.5 |

In step S208, the chiller unit, the water pump and the valve member are plotted on a design layout, and the chiller unit, the water pump and the valve member are connected; where, the chiller unit, the water pump and the valve member are scaled according to the specifications.

Based on data in the above specification table, drawing blocks may be created for all valve members in CAD according to a drawing scale, and can be adapted to various types of chiller units and pipe diameters.

The water pump in the embodiment of the present disclosure may include a chilled water pump and a cooling water pump. The chilled water pump is coupled to the chiller unit through a freezing pipe; the cooling water pump is coupled to the chiller unit through a cooling pipe. During a connection of the chiller unit, water pump and valve member, the following two manners are provided for connecting the freezing pipe and the cooling pipe: the freezing pipe and the cooling pipe are arranged on the same side of the chiller unit; or alternatively, the freezing pipe and the cooling pipe are arranged on opposite sides of the chiller unit.

Where, the arrangement of freezing pipe and cooling pipe entering and exiting on the same side or from different sides may be selected according to an area of the air-conditioning machine room. For example, the area of the air-conditioning machine room is determined; if the area is greater than a preset area threshold, then the freezing pipe and cooling pipe are arranged on opposite sides of the chiller unit; and if the area is smaller than or equal to the preset area threshold, the freezing pipe and the cooling pipe are arranged on the same side of the chiller unit.

Where, the arrangement of the freezing pipe and cooling pipe entering and exiting from different sides may be suitable for a layout of larger air-conditioning machine room. In case that the area of the air-conditioning machine room is too small and the length cannot meet the requirements of entering and exiting from different sides, the arrangement of the freezing pipe and cooling pipe entering and exiting on the same side may be selected.

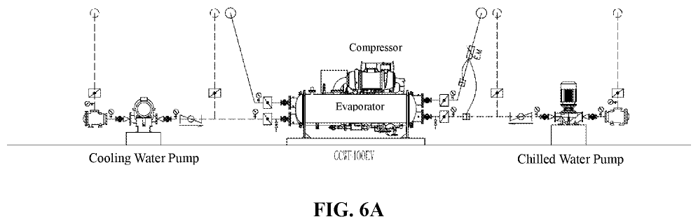

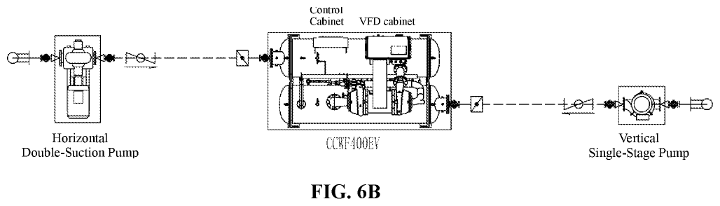

Referring to FIG. 6A and FIG. 6B, which are a cross-sectional view and a top view, respectively, showing an arrangement of the water pump and the chiller unit where the freezing pipe and the cooling pipe enter and exit from different sides for. In the figures, CCWF400EV is the chiller unit, the cooling water pump is provided on the left side of the chiller unit, and the chilled water pump is provided on the right side of the chiller unit. The cooling water pump adopts a horizontal double-suction pump, and the chilled water pump adopts a vertical pipeline pump. The freezing pipe is arranged on the right side of the chiller unit, and the cooling pipe is arranged on the left side of the chiller unit. The freezing pipe and the cooling pipe enter and exit from different sides.

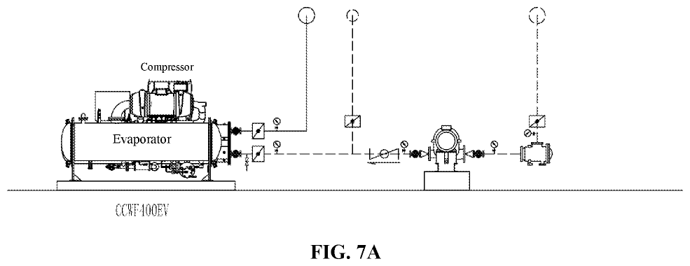

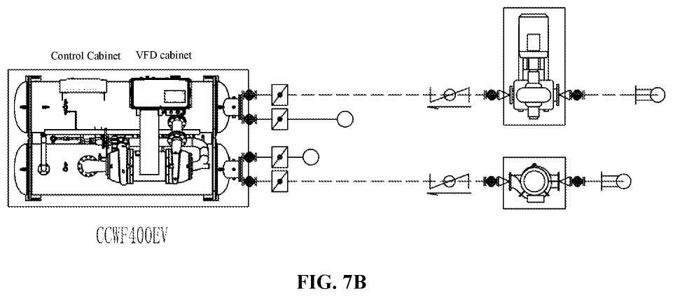

Referring to FIG. 7A and FIG. 7B, which are a cross-sectional view and a top view, respectively, showing an arrangement of the water pump and the chiller unit where the freezing pipe and the cooling pipe enter and exit on the same side. In the figures, the CCWF400EV is the chiller unit, the cooling water pump and the cooling water pump are provided on the left side of the chiller unit. The freezing pipe and the cooling pipe are both provided on the right side of the chiller unit, and the freezing pipe and the cooling pipe enter and exit on the same side.

In addition, the chiller unit and water pump may be connected in a direct connection manner. The direct connection can improve the efficiency of the water pump, while also reducing right-angle elbows in the pipeline and reducing the system resistance.

In summary, the above methods provided by the embodiments of the present disclosure provide a standard layout type for an efficient machine room, which can be directly arranged in a relevant machine room drawing using standardized layout blocks, and this layout type has a minimum usable area while ensuring the normal construction and connection of the units, and the pipelines between equipment connections may also be lengthened to meet the layout of a larger machine room.

In this method, the chiller unit and the water pump are directly connected, which can improve the efficiency of the water pump, while also reducing the right-angle elbows in the pipeline and reducing the system resistance. In the machine room system, a swing check valve in low force, a right-angle filter and other low-resistance pipeline valve are used, which effectively reduces the energy consumption of the system. Meanwhile, the specifications and dimensions of each equipment and valve in the machine room system are scaled in proportional for plotting to ensure that the machine room layout can intuitively reflect the spatial position relationship of the machine room; and this standard layout takes into account a piping space of the connection pipe and the backup pump, which is highly applicable and convenient to use.

A setting device for an air-conditioning machine room provided according to the embodiments of the present disclosure will be described in detail below with reference to the accompanying drawings.

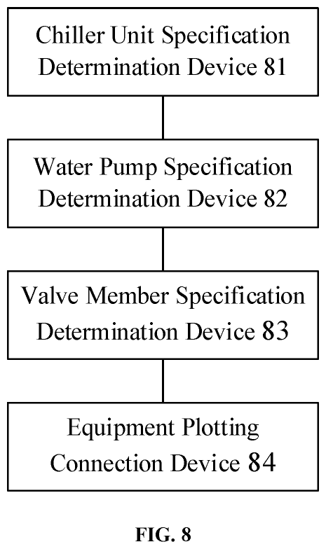

Corresponding to the above method embodiment, an embodiment of the present disclosure provides a setting device for an air-conditioning machine room. The air-conditioning machine room may include: a chiller unit, a water pump and a valve member. Referring to FIG. 8 which shows a schematic structural diagram of a setting device for an air-conditioning machine room, the setting devices of the air-conditioning machine room may include: a chiller unit specification determination device 81, a water pump specification determination device 82, a valve member specification determination device 83 and an equipment plotting connection device 84.

The chiller unit specification determination device 81 is configured to determine a specification of the chiller unit based on a cooling load of a building; wherein the specification of the chiller unit includes an inlet and outlet specification and a pipe diameter.

The water pump specification determination device 82 is configured to determine a specification of the water pump based on a preset system water flow.

The valve member specification determination device 83 is configured to determine a valve member whose specification matches the pipe diameter.

The equipment plotting connection device 84 is configured to plot the chiller unit, the water pump and the valve member on the design layout, and connect the chiller unit, the water pump and the valve member; where, the chiller unit, the water pump and the valve member are scaled according to the specifications.

In the setting device for the air-conditioning machine room provided by the embodiment of the present disclosure, the chiller unit, the water pump, and the valve member are scaled for plotting, and are connected after the specifications of the chiller unit, the water pump, and the valve member are determined. Thus, it is ensured that the spatial location relationship of the machine room can be intuitively reflected during the layout of the air-conditioning machine room. The designed air-conditioning machine room has strong adaptability and is convenient to use.

The pipe diameter of the above-mentioned takeover may include a branch pipe diameter and a main pipe diameter. The above-mentioned chiller unit specification determination device may be configured to: determine a unit model, a cooling capacity and a system temperature difference of the chiller unit based on the cooling load of the building; calculate the branch pipe diameter and the main pipe diameter of the chiller unit based on the unit model, the cooling capacity and the system temperature difference; and adjust the branch pipe diameter and the main pipe diameter of the chiller unit based on a preset flow rate of an air-conditioning water pipe.

The above-mentioned water pump specification determination device may be configured to: determine that the water pump is a vertical single-stage pump if the preset system water flow is smaller than a preset flow threshold; and determining that the water pump is a horizontal double-suction pump if the preset system water flow is greater than or equal to the preset flow threshold.

The above-mentioned valve member specification determination device may be configured to: determine a type of valve member and a correspondence relationship between the type of valve member and the pipe diameter of the chiller unit; and determine the valve member that matches the pipe diameter based on the correspondence relationship.

The valve member may include a check valve, a rubber soft connection, and a right-angle filter. The above-mentioned valve member may be a low-resistance pipeline valve. The check valve may be a swing check valve.

The above-mentioned equipment plotting connection device may be configured to connect the chiller unit and the water pump in a direct connection manner.

The above-mentioned water pump may include a chilled water pump and a cooling water pump. The chilled water pump is coupled to the chiller unit through a freezing pipe; the cooling water pump is coupled to the chiller unit through a cooling pipe. The above-mentioned equipment plotting connection device may be configured to, arrange the freezing pipe and the cooling pipe on the same side of the chiller unit; or alternatively, arrange the freezing pipe and cooling pipe on opposite sides of the chiller unit.

The above-mentioned equipment plotting connection device may be configured to determine an area of the air-conditioning machine room, and arrange the freezing pipe and the cooling pipe on opposite sides of the chiller unit if the area is greater than a preset area threshold. The above-mentioned equipment plotting connection device may be configured to arrange the freezing pipe and the cooling pipe on the same side of the chiller unit if the area is smaller than or equal to the preset area threshold.

It can be clearly understood by persons skilled in the art that, for the convenience and simplicity of description, for the specific working process of the above-described setting device for the air-conditioning machine room, reference can be made to the corresponding process of the setting method for the air-conditioning machine room in the aforementioned embodiment, which will not be repeated here.

Electronic equipment provided according to the embodiments of the present disclosure will be described in detail below with reference to the accompanying drawings.

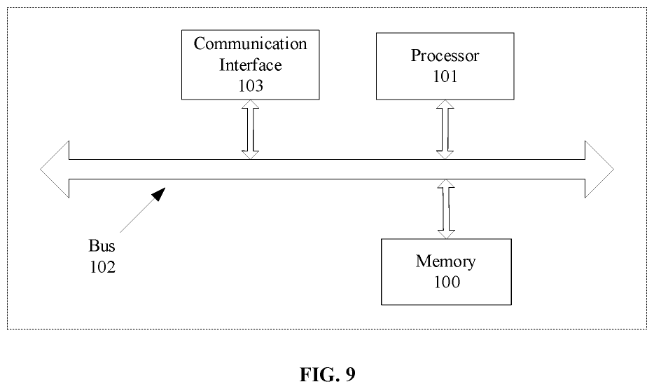

An embodiment of the present disclosure also provides a piece of electronic equipment, which may be configured to perform the above-mentioned setting method for the air-conditioning machine room. With reference to FIG. 9, a schematic structural diagram of a piece of electronic equipment is shown. The electronic equipment may include a memory 100 and a processor 101, where the memory 100 is configured to store one or more computer instructions, and the one or more computer instructions, when executed by the processor 101, enable the above-mentioned setting method for the air-conditioning machine room to be implemented.

The electronic equipment shown in FIG. 9 may also include a bus 102 and a communication interface 103. The processor 101, the communication interface 103 and the memory 100 are connected through the bus 102.

Among them, the memory 100 may include a high-speed random-access memory (RAM, Random Access Memory), and may also include a non-volatile memory (non-volatile memory), such as at least one disk memory. The communication connection between the system network element and at least one other network element is realized through at least one communication interface 103 (which may be wired or wireless), and the Internet, wide area network, local network, metropolitan area network, etc. may be used. The bus 102 may be an ISA bus, a PCI bus, an EISA bus, etc. The bus may be divided into an address bus, a data bus, a control bus, etc. For ease of presentation, only one bidirectional arrow is shown in FIG. 9, but it does not mean that there is only one bus or one type of bus.

The processor 101 may be an integrated circuit chip having signal processing capabilities. During the implementation process, each step of the above method may be completed by instructions in the form of hardware integrated logic circuits or software in the processor 101. The above-mentioned processor 101 may be a general-purpose processor, including a central processing unit (CPU for short), a network processor (NP for short), etc. The processor may also be a digital signal processor (DSP for short), an application specific integrated circuit (ASIC for short), a field-programmable gate array (FPGA for short) or other programmable logic devices, a discrete gate or a transistor logic device, and a discrete hardware component. Each method, step and logical block diagram disclosed in the embodiments of the present disclosure can be implemented or executed. A general-purpose processor may be a microprocessor or the processor may be any conventional processor, etc. The steps of the method disclosed in conjunction with the embodiments of the present disclosure may be directly implemented by a hardware decoding processor, or executed by a combination of hardware and software modules in the decoding processor. The software module may be inserted in a random-access memory, a flash memory, a read-only memory, a programmable read-only memory or an electrically erasable programmable memory, a register and other mature storage media in this field. The storage medium is stored in the memory 100. The processor 101 reads the information in the memory 100 and implement the steps of the method in the foregoing embodiment in combination with the hardware.

Embodiments of the present disclosure also provide a computer-readable storage medium. The computer-readable storage medium may store a computer-executable instructions. When the computer-executable instruction is invoked and executed by the processor, the computer-executable instruction causes the processor to implement the above setting method for an air-conditioning machine room, for specific implementation, references may be made to the method embodiments, which will not be described again here.

A computer program product for the setting method for the air-conditioning machine room, the device and the electronic equipment is provided by an embodiment of the present disclosure. The computer program product may include a computer-readable storage medium storing a program code. The instructions included in the program code may be used to execute the method in the preceding embodiments, for specific implementation, reference may be made to the method embodiments, which will not be described again here.

It can be clearly understood for persons skilled in the art that, for the convenience and simplicity of description, for the specific working process of the system and/or device described above, reference can be made to the corresponding process in the foregoing method embodiment, which will not be described again here.

In addition, in the description of the embodiments of the present disclosure, unless otherwise clearly stated and limited, the terms “installation,” “connection” and “coupling” should be understood in a broad sense. For example, it may be a fixed connection or a detachable connection, or it may be integrally connected; it may be a mechanical connection or an electrical connection; it may be a direct connection or an indirect connection through an intermediate medium; and it may be an internal connection between two components. For those of ordinary skill in the art, the specific meanings of the above terms in this disclosure may be understood on a case-by-case basis.

If functions are implemented in the form of software functional units and sold or used as independent products, then these functions may be stored in a computer-readable storage medium. Based on this understanding, the technical solution of the present disclosure is essentially or the part that contributes to the relevant technology or the part of the technical solution may be embodied in the form of a software product. The computer software product is stored in a storage medium and includes several instructions that are configured to cause a computer device (which may be a personal computer, a server, or a network device, etc.) to execute all or part of the steps of the methods described in various embodiments of the present disclosure. The aforementioned storage medium includes: a U disk, a mobile hard disk, a read-only memory (ROM), a random-access memory (RAM), a magnetic disk or an optical disk and other media that can store a program code.

In the description of the present disclosure, it should be noted that the orientation or positional relationship indicated by terms, such as “center,” “upper,” “lower,” “left,” “right,” “vertical,” “horizontal,” “inner,” “outer,” etc. is based on the orientation or positional relationship shown in the drawings, which is only for the convenience of describing the present disclosure and simplifying the description, and does not intended to indicate or imply that the device or element referred to must have a specific orientation or be constructed or operated in a specific orientation, and therefore should not be construed as limitations on the present disclosure. Furthermore, the terms “first,” “second” and “third” are used for descriptive purposes only and should not be construed as indicating or implying relative importance.

Finally, it should be noted that the above-mentioned embodiments are only specific implementations of the present disclosure being used to illustrate the technical solutions of the present disclosure rather than being intended to limit them. The protection scope of the present disclosure is not limited to this. Notwithstanding the detailed description of this disclosure by reference to the foregoing embodiments, persons of ordinary skill in the art shall understand that: it is still possible for any person familiar with the technical field to modify the technical solutions recorded in the foregoing embodiments, to conceive variations or make equivalent substitutions to some of the technical features, within the technical scope disclosed in the present disclosure. These modifications, variations or substitutions do not cause the essence of the corresponding technical solutions to deviate from the spirit and scope of the technical solutions of the embodiments of the present disclosure, and shall be included within the protection scope of the present disclosure. Therefore, the protection scope of the present disclosure should be determined by the protection scope of the claims.

### INDUSTRIAL APPLICABILITY

The present disclosure provides a setting method for an air-conditioning machine room, a device, electronic equipment and a readable storage medium. Among them, the method includes steps of: determining a specification of a chiller unit based on a cooling load of a building; where the specification of the chiller unit include an inlet and outlet specification and a pipe diameter; determining a specification of a water pump based on a preset system water flow; determining a valve member, where a specification of the valve member matches the pipe diameter; and plotting the chiller unit, the water pump and the valve member on a design layout, and connecting the chiller unit, the water pump and the valve member; where, the chiller unit, the water pump and the valve member are scaled according to the specifications. In this method, after the specifications of the chiller unit, the water pump and the valve member are determined, the chiller unit, the water pump and the valve member are scaled for plotting, and are connected, this ensures that the spatial location relationship of the machine room can be intuitively reflected when the air-conditioning machine room is laid out. The designed air-conditioning machine room is highly adaptable and convenient to use.

In addition, it can be understood that the setting method for the air-conditioning machine room, the device, the electronic equipment and the readable storage medium of the present disclosure are reproducible and can be applied in various applications. For example, the setting method for the air-conditioning machine room, the device, the electronic equipment and the readable storage medium of the present disclosure may be applied to the field of air-conditioning technology, etc.

1.-20. (canceled)

21. A setting method for an air-conditioning machine room, comprising:
determining a specification of a chiller unit of the air-conditioning machine room based on a cooling load of a building, the specification of the chiller unit including an inlet and outlet specification and a pipe diameter;
determining a specification of a water pump of the air-conditioning machine room based on a preset system water flow;
determining a valve member of the air-conditioning machine room, a specification of the valve member matching the pipe diameter; and
plotting the chiller unit, the water pump, and the valve member on a design layout, and connecting the chiller unit, the water pump, and the valve member, the chiller unit, the water pump, and the valve member being proportionally scaled according to the specification of the chiller unit, the specification of the water pump, and the specification of the valve member.

22. The setting method according to claim 21, wherein:
the pipe diameter of the pipe includes a branch pipe diameter and a main pipe diameter; and
determining the specification of the chiller unit based on the cooling load of the building includes:
determining a unit model, a cooling capacity, and a system temperature difference of the chiller unit based on the cooling load of the building;
calculating the branch pipe diameter and the main pipe diameter of the chiller unit based on the unit model, the cooling capacity, and the system temperature difference; and
adjusting the branch pipe diameter and the main pipe diameter of the chiller unit based on a preset flow rate of an air-conditioning water pipe.

23. The setting method according to claim 21, wherein determining the specification of the water pump based on the preset system water flow includes:
determining that the water pump is a vertical single-stage pump in response to the preset system water flow being smaller than a preset flow threshold; and
determining that the water pump is a horizontal double-suction pump in response to the preset system water flow being greater than or equal to the preset flow threshold.

24. The setting method according to claim 21, wherein determining the valve member includes:
determining a type of the valve member and a correspondence relationship between the type of valve member and the pipe diameter of the chiller unit; and
determining the valve member matching the pipe diameter based on the correspondence relationship.

25. The setting method according to claim 21, wherein the valve member includes a check valve, a rubber soft connection, and a right-angle filter.

26. The setting method according to claim 25, wherein the valve member includes a low-resistance pipeline valve, and the check valve includes a swing check valve.

27. The setting method according to claim 21, wherein connecting the chiller unit, the water pump, and the valve member includes:
connecting the chiller unit with the water pump in a direct connection manner.

28. The setting method according to claim 21, wherein:
the water pump includes a chilled water pump and a cooling water pump, the chilled water pump is coupled to the chiller unit through a freezing pipe, and the cooling water pump is coupled to the chiller unit through a cooling pipe; and
connecting the chiller unit, the water pump, and the valve member includes:
arranging the freezing pipe and the cooling pipe on a same side of the chiller unit; or
arranging the freezing pipe and the cooling pipe on opposite sides of the chiller unit.

29. The setting method according to claim 21, wherein:
the water pump includes a chilled water pump and a cooling water pump, the chilled water pump is coupled to the chiller unit through a freezing pipe, and the cooling water pump is coupled to the chiller unit through a cooling pipe; and
connecting the chiller unit, the water pump, and the valve member includes:
determining an area of the air-conditioning machine room; and
connecting the chiller unit, the water pump, and the valve member according to the area of the air-conditioning machine room, including:
arranging the freezing pipe and the cooling pipe on opposite sides of the chiller unit in response to the area being greater than a preset area threshold; or
arranging the freezing pipe and the cooling pipe on a same side of the chiller unit in response to the area being less than or equal to the preset area threshold.

30. Electronic equipment comprising:
a processor; and
a memory storing a computer-executable instruction that, when executed by the processor, causes the processor to:
determine a specification of a chiller unit of the air-conditioning machine room based on a cooling load of a building, the specification of the chiller unit including an inlet and outlet specification and a pipe diameter;
determine a specification of a water pump of the air-conditioning machine room based on a preset system water flow;
determine a valve member of the air-conditioning machine room, a specification of the valve member matching the pipe diameter; and
plot the chiller unit, the water pump, and the valve member on a design layout, and connect the chiller unit, the water pump, and the valve member, the chiller unit, the water pump, and the valve member being proportionally scaled according to the specification of the chiller unit, the specification of the water pump, and the specification of the valve member.

31. The electronic equipment according to claim 30, wherein:
the pipe diameter of the pipe includes a branch pipe diameter and a main pipe diameter; and
the instruction further causes the processor to:
determine a unit model, a cooling capacity, and a system temperature difference of the chiller unit based on the cooling load of the building;
calculate the branch pipe diameter and the main pipe diameter of the chiller unit based on the unit model, the cooling capacity, and the system temperature difference; and
adjust the branch pipe diameter and the main pipe diameter of the chiller unit based on a preset flow rate of an air-conditioning water pipe.

32. The electronic equipment according to claim 30, wherein the instruction further causes the processor to:
determine that the water pump is a vertical single-stage pump in response to the preset system water flow being smaller than a preset flow threshold; and
determine that the water pump is a horizontal double-suction pump in response to the preset system water flow being greater than or equal to the preset flow threshold.

33. The electronic equipment according to claim 30, wherein the instruction further causes the processor to:
determine a type of the valve member and a correspondence relationship between the type of valve member and the pipe diameter of the chiller unit; and
determine the valve member matching the pipe diameter based on the correspondence relationship.

34. The electronic equipment according to claim 30, wherein the valve member includes a check valve, a rubber soft connection, and a right-angle filter.

35. The electronic equipment according to claim 34, wherein the valve member includes a low-resistance pipeline valve, and the check valve includes a swing check valve.

36. The electronic equipment according to claim 30, wherein the instruction further causes the processor to:
connect the chiller unit with the water pump in a direct connection manner.

37. The electronic equipment according to claim 30, wherein:
the water pump includes a chilled water pump and a cooling water pump, the chilled water pump is coupled to the chiller unit through a freezing pipe, and the cooling water pump is coupled to the chiller unit through a cooling pipe; and
the instruction further causes the processor to:
arrange the freezing pipe and the cooling pipe on a same side of the chiller unit; or
arrange the freezing pipe and the cooling pipe on opposite sides of the chiller unit.

38. The electronic equipment according to claim 30, wherein:
the water pump includes a chilled water pump and a cooling water pump, the chilled water pump is coupled to the chiller unit through a freezing pipe, and the cooling water pump is coupled to the chiller unit through a cooling pipe; and
the instruction further causes the processor to:
determine an area of the air-conditioning machine room; and
connect the chiller unit, the water pump, and the valve member according to the area of the air-conditioning machine room, including:
arranging the freezing pipe and the cooling pipe on opposite sides of the chiller unit in response to the area being greater than a preset area threshold; or
arranging the freezing pipe and the cooling pipe on a same side of the chiller unit in response to the area being less than or equal to the preset area threshold.

39. A non-transitory computer-readable storage medium storing a computer-executable instruction that, when invoked and executed by a processor, causes the processor to:
determine a specification of a chiller unit of the air-conditioning machine room based on a cooling load of a building, the specification of the chiller unit including an inlet and outlet specification and a pipe diameter;
determine a specification of a water pump of the air-conditioning machine room based on a preset system water flow;
determine a valve member of the air-conditioning machine room, a specification of the valve member matching the pipe diameter; and
plot the chiller unit, the water pump, and the valve member on a design layout, and connect the chiller unit, the water pump, and the valve member, the chiller unit, the water pump, and the valve member being proportionally scaled according to the specification of the chiller unit, the specification of the water pump, and the specification of the valve member.

40. The storage medium according to claim 39, wherein:
the pipe diameter of the pipe includes a branch pipe diameter and a main pipe diameter; and
the instruction further causes the processor to:
determine a unit model, a cooling capacity, and a system temperature difference of the chiller unit based on the cooling load of the building;
calculate the branch pipe diameter and the main pipe diameter of the chiller unit based on the unit model, the cooling capacity, and the system temperature difference; and
adjust the branch pipe diameter and the main pipe diameter of the chiller unit based on a preset flow rate of an air-conditioning water pipe.
